(19) United States
(12) Patent Application Publication
(10) Pub. No.: US 2009/0125569 A1
(43) Pub. Date: May 14, 2009

(54) DYNAMIC REPLICATION ON DEMAND POLICY BASED ON ZONES

(76) Inventors: Jeffrey Mark Achtermann, Austin, TX (US); Steven Armand Jarvis, Austin, TX (US); Liliana Orozco, Del Valle, TX (US); Brian George Vassberg, Austin, TX (US)

Correspondence Address: IBM CORP (YA);C/O YEE & ASSOCIATES PC, P.O. BOX 802333, DALLAS, TX, 75380, US

(21) Appl. No.: 11/937,127

(22) Filed: Nov. 8, 2007

(51) Int. Cl. G06F 7/00

(52) U.S. Cl. 707/204

(57) ABSTRACT

The exemplary embodiments provide a computer implemented method, data processing system, and computer usable program code for automatically replicating a file. A request to download a file is received from a requester. The location of the requester and of each server on the network is mapped. A determination of whether a copy of the file exists on a content server associated with the requester, based on the location of the requester and the location of the content server, is made. In response to a determination that a copy of the file does not exist on a content server associated with the requester, a content server associated with the requester to which to replicate the file based on the location of the requester and the location of the content server is determined. The requester is notified of the determined content server. The file is replicated to the determined content server.

### BACKGROUND OF THE INVENTION

1. Field of the Invention

The present invention relates generally to data management. More specifically the present invention relates to dynamic replication of files based on demand.

2. Description of the Related Art

When many client data processing systems need to download the same file, a common practice is to replicate the file to multiple servers in order to handle the load and keep the transfer rate high. If the client data processing systems that will be pulling the file are geographically dispersed, locating the servers near the client data processing systems that will be downloading the file also proves useful. Locating the servers near the client data processing systems that will be downloading the files maximizes the use of local area networks (LANs) while minimizing the use of wide area networks (WANs). WANs are often much slower than LANs, which will slow download rates. WANs are also shared by many users, so a large file transfer can impact other users and applications.

Various products, such as the IBM Tivoli Dynamic Content Delivery (DCD) product, provide a download service for client data processing systems needing access to large files. In the case of the Dynamic Content Delivery (DCD) product, the administrator publishes a file into the DCD product and the file is uploaded to one content server. A content server is a server that allows clients to upload and download files. A content server is a server that has content, files that are intended to be downloaded by client data processing systems. The management center keeps an inventory of the files stored on the content server. The file can then be replicated to multiple content servers positioned around the network so that the file can be available to client data processing systems all over the network.

A client data processing system requests to download a file from a centralized server, known as the management center, which has access to the location(s) of the file. The management center returns to the client data processing system a list of the closest servers the client data processing system can use to download the file. The management center uses the internet protocol (IP) address, subnet address, and domain of the client data processing system to determine the closest servers the client data processing system can use to download the file. The administrator can set up network zones and regions to help the management center determine proximity and maximize LAN usage. The zones can be set up using IP address ranges or a wild carded domain, such as *.city.company.com. A region can contain multiple zones. Zones can be set to limit incoming or outgoing traffic from the client data processing systems.

Typically, when an administrator publishes a file, target servers and level of propagation need to be specified. For example, the file can be set to be replicated to 50 percent of the servers in a particular region or to be replicated to two (2) of the servers in region 1 and region 2. The administrator can also create a specific target list of servers from all over the network and have the file replicate to all of those servers. Regardless of replication target lists and replication level set, in order to minimize WAN usage, the administrator must know ahead of time the location of the client data processing systems needing the file. In the worst case, the administrator can just have the file replicate to all servers. However, this solution is not very efficient, especially if only a subset of client data processing systems in specific locations need the file.

For large organizations with a variety of applications and data processing system types, predicting what data processing systems will need to download a particular file is often difficult, or at least a manually intensive effort. Mapping the predicted data processing systems to the best download servers to host the file often proves to be even more tedious.

### SUMMARY OF THE INVENTION

The exemplary embodiments provide a computer implemented method, data processing system, and computer usable program code for automatically replicating a file. A request to download a file is received from a requester. The location of the requestor and of each server on the network is mapped. A determination of whether a copy of the file exists on a content server associated with the requestor, based on the location of the requestor and the location of the content server, is made. In response to a determination that a copy of the file does not exist on a content server associated with the requester, a content server associated with the requestor to which to replicate the file based on the location of the requestor and the location of the content server is determined. The requestor is notified of the determined content server. The file is replicated to the determined content server.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which the illustrative embodiments may be implemented;

FIG. 3 is a block diagram of a system for replicating files according to an exemplary embodiment;

FIGS. 4A & 4B are a flowchart illustrating the operation of dynamically replicating a file across a network according to an exemplary embodiment; and

FIG. 5 is a flowchart illustrating the operation of automatically removing replicated files from a content server in accordance with an exemplary embodiment.

### DETAILED DESCRIPTION OF THE PREFERRED EMBODIMENT

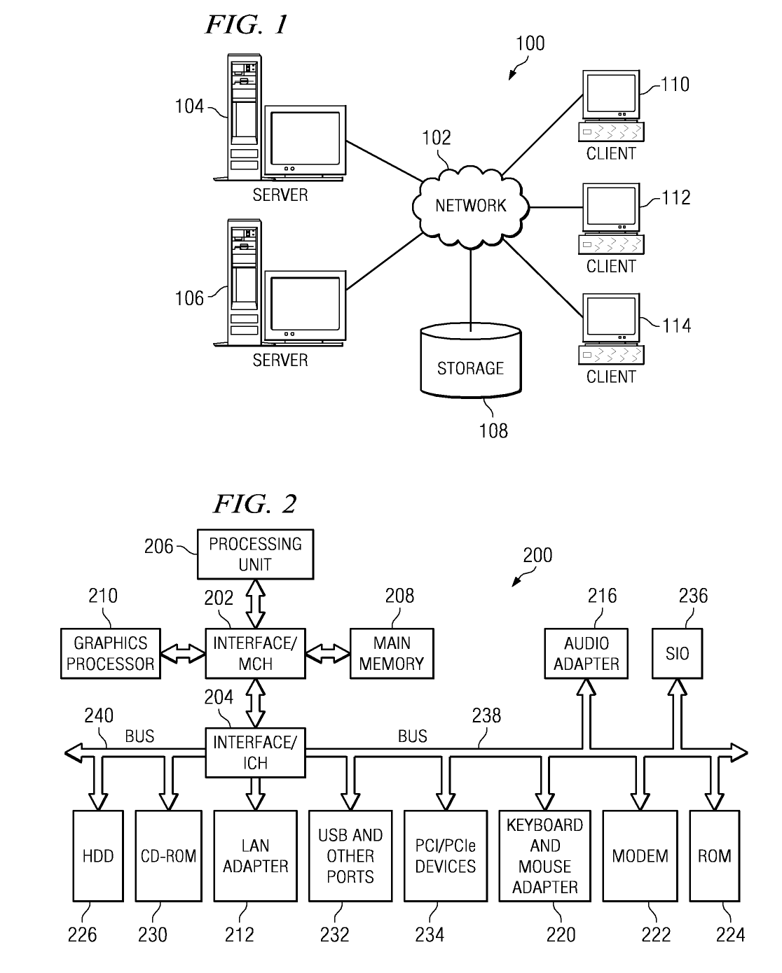

With reference now to the figures and in particular with reference to FIGS. 1-2, exemplary diagrams of data processing environments are provided in which illustrative embodiments may be implemented. It should be appreciated that FIGS. 1-2 are only exemplary, and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

When many client data processing systems need to download the same file, a common practice is to replicate the file to multiple servers in order to handle the load and keep the transfer rate high. If the client data processing systems that will be pulling the file are geographically dispersed, locating the servers near the client data processing systems that will be downloading the file also proves useful.

Typically, when an administrator publishes a file, target servers and a level of propagation need to be specified. For example, the file can be set to be replicated to 50 percent of servers in a particular region or the file can be set to be replicated to two (2) of the servers in region 1 and region 2. The administrator can also create a specific target list of servers from all over the network and have the file replicate to all of those servers. Regardless of replication target lists and the replication level set, in order to minimize WAN usage, the administrator must know ahead of time the location of the client data processing systems needing the file. In the worst case, the administrator can just have the file replicate to all servers. However, this solution is not very efficient, especially if only a subset of client data processing systems in specific locations need the file.

For large organizations with a variety of applications and data processing system types, predicting what data processing systems will need to download a particular file is often difficult, or at least a manually intensive effort. Mapping the predicted data processing systems to the best download servers to host the file often proves to be even more tedious.

Exemplary embodiments provide for file replication by monitoring the demand for the file and replicating the file to the appropriate servers when conditions indicate that additional servers are needed. Thus, the user administrating the system only has to upload the file to a single, initial server and set the replication policy to automatic. The administrator does not have to specify the number, names, or even the location of the data processing systems that will download the file. Determining the data processing systems that will replicate the file is performed automatically by the host server.

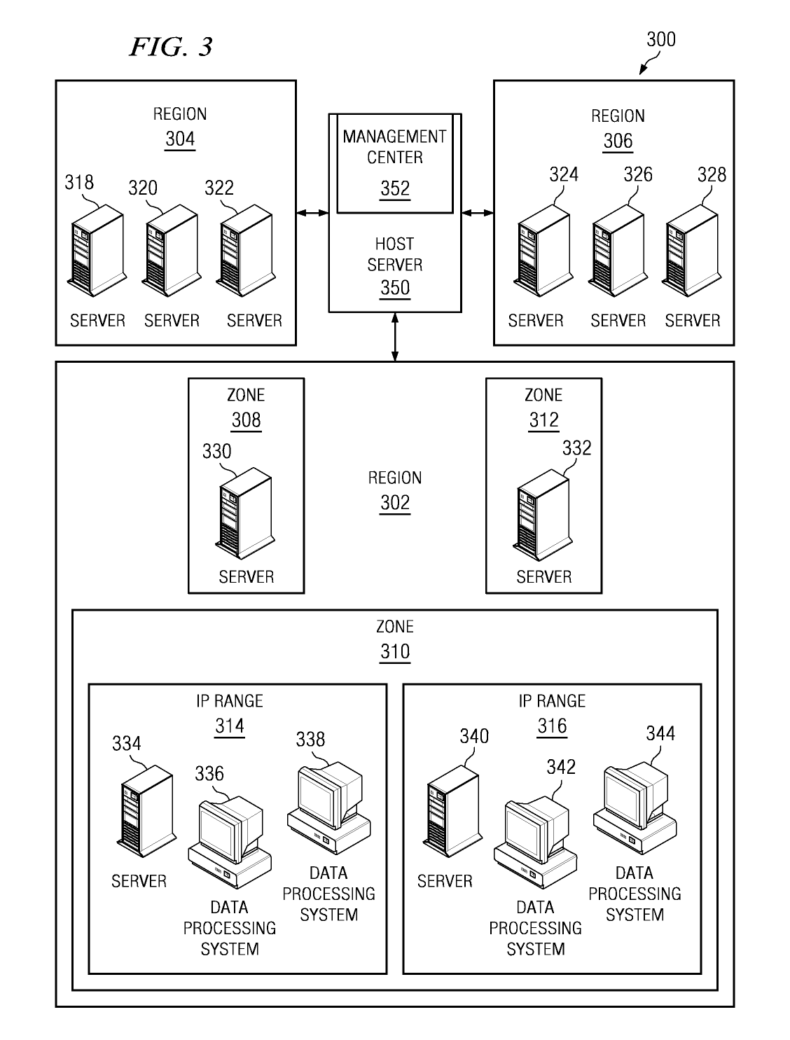

Returning to the figures, FIG. 3 is a block diagram of a system for replicating files according to an exemplary embodiment. System 300 is a WAN, which may be implemented as network 102 in FIG. 1. System 300 comprises numerous servers and data processing systems, which are divided into zones and regions. While the present exemplary embodiment depicts a WAN comprised of eleven (11) servers and four (4) data processing systems divided into three (3) regions, three (3) zones, and two (2) IP ranges, the depicted architecture is meant in no way to limit the exemplary embodiments to the architecture depicted. Those skilled in the art will realize many ways of structuring system 300 to include fewer or more servers and or data processing systems and to include fewer or more regions and zones. Various exemplary embodiments contemplate all such variations of the make up of system 300.

System 300 comprises regions 302, 304, 306 and host server 350. Region 304 comprises servers 318, 320, and 322. Region 306 comprises servers 324, 326 and 328. Region 302 comprises zones 308, 310, and 312. Zone 308 comprises server 330. Zone 312 comprises server 332. Zone 310 comprises IP ranges 314 and 316. IP range 314 comprises server 334 and data processing systems 336 and 338. IP range 316 comprises server 340 and data processing systems 342 and 344. Host server 350 comprises management center 352. Thus, system 300 depicts a possible WAN divided into various zones and regions for distributing file content.

In an exemplary embodiment, a zone is comprised of a domain. For example, a zone, such as zone 310, would be defined by the IP domain of *.cityname.companyname.com. Further, a subnet address is calculated by taking the subnet mask of a client data processing system and ORing the subnet mask with the IP address of the data processing system. For example, a client data processing system has a subnet mask of 255.255.255.0 and an IP address of 192.168.1.100. ORing the IP address and subnet mask together produces a result that any data processing system that has an IP address that matches 192.186.1.* is considered to be on the same subnet and is automatically matched to content servers on the same subnet. A region is created by an administrator by manually assigning IP domains or IP ranges to a region.

Servers 318, 320, 322, 324, 326, 328, 330, 332, 334, 340, and 350 may be implemented as data processing systems, such as data processing system 200 in FIG. 2. Data processing systems 336, 338, 342, and 344 may be implemented as a data processing system, such as data processing system 200 in FIG. 2.

In the depicted exemplary embodiment, a region refers to a portion of a WAN, which typically will be defined by an association with a geographic area. A zone is sub-section of a region. A zone may be identified with a smaller geographic area within the region or with a particular business, business unit, or LAN. An IP range is further subdividing of a zone, and may be associated with a specific LAN, department or business unit. For example, for a corporation, a region may represent North America, a zone may then represent an office in Seattle, Wash., and an IP range could define the accounting department within the office in Seattle, Wash. Similarly, as another example, for a corporation, a region may represent North America, a zone may then represent west coast, and an IP range may define the specific company or branch office in the west coast.

In an exemplary embodiment, a user that wants to upload a file queries management center 352 to determine to which server to upload the file. Management center 352 returns a list of the best servers to which to upload the file. Management center 352 returns a list of servers to the user in case the first server or the first several servers are unavailable to handle the upload. During this process management center 352 creates an entry for the file that includes the location where the file is stored and the replication policy, which is set by the user at this time.

Management center 352 receives requests from various client data processing systems to download the uploaded file. Management center 352 then determines from what regions and zones, if appropriate, the requests are coming. If the file is already available on a server in the zone or region from which a request originates, management center 352 directs the requesting client data processing system to download the file from the server containing a copy of the file.

If there is not a server in the region or zone that contains a copy of the file to be downloaded, management center 352 determines a server out of all the servers in the region or zone from which to replicate the file. The file replication is started and the requesting client data processing system is informed of which server to contact to download the file from and when the file will be available to request to download.

Servers 318, 320, 322, 324, 326, 328, 330, 332, 334, 340, and 350 are all content servers. That is, the servers all have content, files, intended for downloading by client data processing systems. Servers 318, 320, 322, 324, 326, 328, 330, 332, 334, 340, and 350 do not need to be dedicated content servers. That is, any server that contains content to be replicated or downloaded can be considered a content server. Therefore, any of servers 318, 320, 322, 324, 326, 328, 330, 332, 334, 340, and 350 may be a file server or print server and still be content servers as well.

Exemplary embodiments provide a method for automating the replication of a file across a network in order to handle the load of data processing systems downloading the file, scaling to the number of client data processing systems, and positioning the file near the data processing systems that will be downloading the file. For example, take the case where a large, global bank needs to update an application used by stockbrokers of the bank. The stockbrokers all work in various branch offices, spread around the world. The branch offices are connected through slow WANs back to the central management facility of the bank. Frequently there is more than one stockbroker in a branch office, so reducing the number of times the file has to be transferred over the WAN is desirable.

In other words, the bank desires to transfer the file over the WAN only once and make the file available to be downloaded from a local server in the branch office. However, not all of the branch offices have stockbrokers. Some branch offices are simply banks that do not offer brokerage services. These branch offices will never need the file. The first version of the file is in English only, so the file will only be used in English speaking countries.

Thus, using system 300 as an example, management center 352 would be the management center of the bank. Depending on the origination of the bank, either branch offices could be associated with zones or IP ranges. For purposes of this example, branch offices are associated with IP ranges, such as IP ranges 314 and 316.

Therefore, when management center 352 receives a request to download the file from a client data processing system, such as data processing system 336, management center 352 determines if an English language version of the file resides on any servers in IP range 314. If management center 352 determines that an English language version of the file does not reside on any servers in IP range 314, management center 352 then determines if server 334 in IP range 314 has a copy of the file to be downloaded.

If server 334 does not have a copy of the file to be downloaded, management center 352 will replicate the requested file onto server 334. Any future inquiries from a data processing system in IP range 314 will then be directed to download the requested file from server 334.

Further, if a request to download a file originated from a region were a copy of the file did not exist to download, management center 352 would automatically determine a server within the region to replicate the file to.

If management center 352 determines that there are no servers in the zone comprising IP range 314 to replicate the file to, management center 352 determines if another server in the same zone, but not in the same IP range, as the requesting data processing system has a copy of the file for downloading. In FIG. 3, management center 352 would then check other servers in zone 310, such as server 340 of IP range 316 to see if any of the other servers have a copy of the requested file for download.

If management center 352 determines that another server in the same zone has a copy of the file for downloading, then management center 352 directs the requesting data processing system to download the file from the server containing the copy of the file. In FIG. 3, management center 352 would then direct data processing system 336 to request download of the file from server 340 of IP range 316.

If no servers in the same zone as the requesting data processing system have a copy of the file requested to be downloaded, management center 352 then determines if any servers in the same region as the requesting data processing system have a copy of the file requested to be downloaded. If management center 352 determines that another server in the same region has a copy of the file for downloading, then management center 352 directs the requesting data processing system to download the file from the server containing the copy of the file. In FIG. 3, management center 352 directs data processing system 336 to request download of the file from server 330 of zone 308 or server 332 of zone 312.

In an alternate embodiment, zones are configured such that if the requested file is not available on a server within the zone, the client will wait until the management center replicates the file to a server in the zone.

The present exemplary embodiment has been explained as checking the same region as the requesting data processing system to find a server with a copy of a requested file for downloading and then replicating the file to a server in the region if no copies exist. An alternate embodiment provides that if a server is not found with a copy of the file in the same zone as the requesting data processing system, then the file is replicated to a server within the same zone. Further still, another exemplary embodiment provides that if a server is not found with a copy of the file in the same IP range as the requesting data processing system, then the file is replicated to a server within the same IP range.

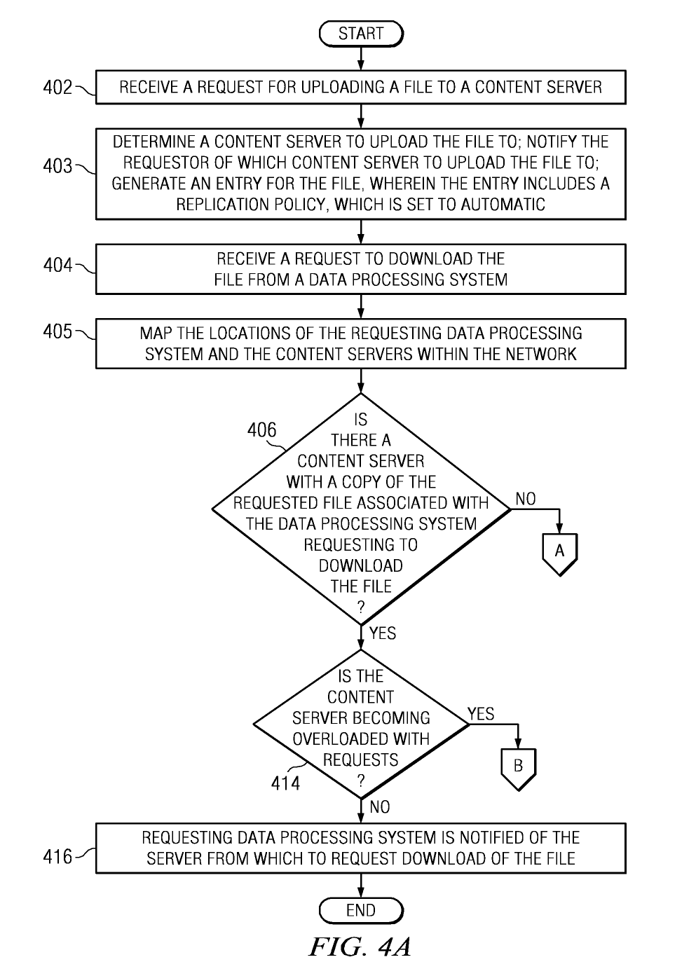

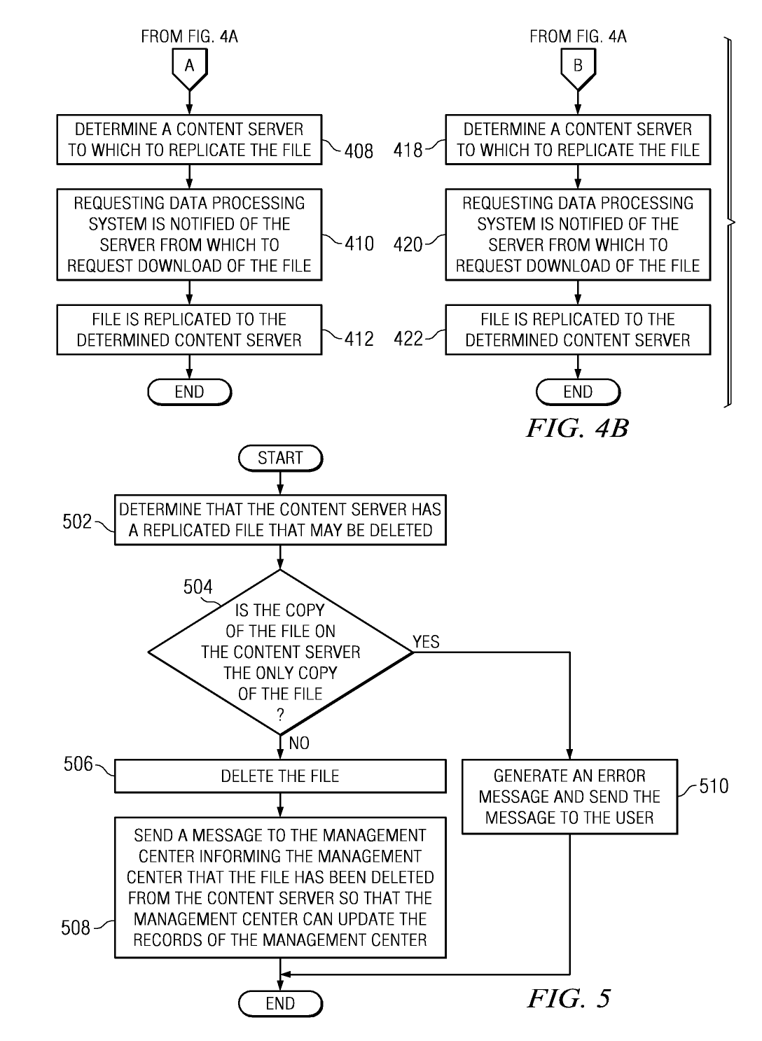

FIGS. 4A & 4B are a flowchart illustrating the operation of dynamically replicating a file across a network according to an exemplary embodiment. The operation begins when a management center, such as management center 352 in FIG. 3, which may be implemented in a data processing system such as data processing system 200 in FIG. 2, receives a request for uploading a file to a content server (step 402). The management center determines a content server to upload the file to; notifies the requester of which server to upload the file to; and generates an entry for the file, wherein the entry includes a replication policy, which is set to automatic (step 403). The management center then receives a request to download the file from a data processing system (step 404). The management center maps the locations on the network of the requesting data processing system and the servers within the network based on a hierarchy of IP range, zone, and region (step 405). The management center determines if there is a content server with a copy of the requested file associated with the data processing system requesting to download the file based on the mapped locations of the requester and servers within the network (step 406).

If the management center determines that there is not a content server with a copy of the requested file associated with the data processing system requesting to download the file (a “no” output to step 406), the management center determines a content server to which to replicate the file (step 408). The requesting data processing system is notified of the server from which to request download of the file (step 410). The file is replicated to the determined content server (step 412) and the process ends.

If the management center determines that there is a content server with a copy of the requested file associated with the data processing system requesting to download the file (a “yes” output to step 406), the management center determines if the content server is becoming overloaded with requests (step 414).

The management center determines if a content server is becoming overloaded by keeping track of download requests by data processing systems associated with the content server. Once the number of requests reaches a certain predetermined level, the content served is deemed to be overloaded. The predetermined level may be defined in a number of ways, including, for example, but not limited to, an amount of bandwidth usage, total number of requests, requests per time period, percentage of requests for download versus total operations performed, and so forth.

If the management center determines that the content server is not becoming overloaded with requests (a “no” output to step 414), the requesting data processing system is notified of the server from which to request download of the file (step 416) and the process ends.

If the management center determines that the content server is becoming overloaded with requests (a “yes” output to step 414), the management center determines a content server to which to replicate the file (step 418). The requesting data processing system is notified of the server from which to request download of the file (step 420). The file is replicated to the determined content server (step 422) and the process ends.

The notification discussed in steps 412, 416 and 422 may include a time for the requesting data processing system to make a request to download the file as well as the identity of the server containing the file in which to make the request to download the file. The time may be determined based on the size of the file to be transferred and the transfer speed between the management center and the content server receiving the file. Once the requesting data processing system has received the notification, the requesting data processing system proceeds to request download of the file from the content server once the content server has received the file.

In an alternate embodiment, rather that the management center determining that the content server is becoming overloaded with requests, the content server alerts the management server that the content server is becoming overloaded with requests to download the file.

In this manner, a file will be propagated only to zones where client data processing systems have requested to download the file. Further, a file will be propagated only to multiple servers in a zone when more client data processing systems request the file than the content server can handle. Additionally, if space is a limitation on some content servers, files replicated to a content server due to overload on neighboring content servers or automatic replications can be flushed out on a last accessed time basis so that when requests die off for a particular file, the content server can delete the file to make room for a new file. Also, note that zones, domains, and regions can have properties that say whether or not a client can pull a file from outside of the zone/domain/region.

FIG. 5 is a flowchart illustrating the operation of automatically removing replicated files from a content server in accordance with an exemplary embodiment. The operation begins when a content server, such as server 104 in FIG. 1, determines that the content server has a replicated file that may be deleted (step 502). The content server determines if the copy of the file on the content server is the only copy of the file (step 504). If the content server determines that the copy of the file on the content server is not the only copy of the file (a “no” output to step 504), the content server deletes the file (step 506). The content server sends a message to the management center informing the management center that the file has been deleted from the content server so that the management center can update the records of the management center (step 508) and the process ends. A management center, upon receipt of a message from a content server that a file has been deleted, updates records regarding existing copies of the file and stores the updated record.

If the content server determines that the copy of the file on the content server is the only copy of the file (a “yes” output to step 504), then the content server generates an error message and sends the message to the user (step 510), such as a systems administrator, informing the user that the file cannot be deleted because the file on the content server is the only copy of the file on the network, and the operation ends.

Thus, exemplary embodiments provide for automating the replication of a file across a network in order to handle the load of data processing systems downloading the file, scaling the replication to the number of data processing systems requesting to download the file, and positioning the file near the data processing systems that will be downloading the file.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for automatically replicating a file, the computer implemented method comprising:
receiving a request from a requester to download the file;
mapping a location of the requestor on a network and a location of each content server on the network;
determining that a copy of the file exists on a content server associated with the requester, based on the location of the requester and the location of the content server;
in response to a determination that a copy of the file does not exist on a content server associated with the requester, determining a content server associated with the requester to which to replicate the file based on the location of the requester and the location of the content server to form a determined content server;
notifying the requester of the determined content server; and
replicating the file to the determined content server.

2. The computer implemented method of claim 1, further comprising:
receiving a first request to upload the file to be replicated from a first requester;
determining a first content server to upload the file to; and
generating an entry for the file, wherein the entry comprises a location of the first content server and a replication policy for the file, wherein the replication policy for the file is set to automatic.

3. The computer implemented method of claim 2, further comprising:
updating the entry to comprise each content server to which the file is replicated.

4. The computer implemented method of claim 1, wherein mapping the location of the requester on the network and the location of each content server on the network comprises:
determining the location of the requestor and each content server within the network based on a hierarchy.

5. The computer implemented method of claim 4, wherein the hierarchy comprises a hierarchy based on a subnet address, a zone, and a region.

6. The computer implemented method of claim 5, wherein at least one of the zone or the region has a property setting that determines whether the requester is permitted to download the file from a content server that is not located within the zone or the region.

7. The computer implemented method of claim 2, further comprising:
determining, by a second content server, that the second content server has a copy of a replicated file that may be deleted;
determining if the copy of the replicated file on the second content server is an only copy of the replicated file on the network;
responsive to a determination that the copy of the replicated file on the second content server is not the only copy of the replicated file on the network, deleting the copy of the replicated file from the second content server; and
updating an entry for the replicated file indicating that the copy of the replicated file no longer exists on the second content server.

8. The computer implemented method of claim 1, further comprising:
responsive to the determined content server having uploaded the file, downloading the file by the requestor.

9. The computer implemented method of claim 1, wherein the determined content server comprises a plurality of content servers.

10. The computer implemented method of claim 9, further comprising:
responsive to the determined content server having uploaded the file, downloading a portion of the file from one or more of the plurality of content servers that comprise the determined content server.

11. A computer program product comprising:
a computer recordable medium having computer usable program code for automatically replicating a file, the computer program product comprising:
computer usable program code for receiving a request from a requester to download the file;
computer usable program code for mapping a location of the requestor on a network and a location of each content server on the network;
computer usable program code for determining that a copy of the file exists on a content server associated with the requester, based on the location of the requester and the location of the content server;
computer usable program code, in response to a determination that a copy of the file does not exist on a content server associated with the requester, for determining a content server associated with the requester to which to replicate the file based on the location of the requester and the location of the content server to form a determined content server;
computer usable program code for notifying the requester of the determined content server; and
computer usable program code for replicating the file to the determined content server.

12. The computer program product of claim 11, further comprising:
computer usable program code for receiving a first request to upload the file to be replicated from a first requester;
computer usable program code for determining a first content server to upload the file to; and
computer usable program code for generating an entry for the file, wherein the entry comprises a location of the first content server and a replication policy for the file, wherein the replication policy for the file is set to automatic.

13. The computer program product of claim 12, further comprising:
computer usable program code for updating the entry to comprise each content server to which the file is replicated.

14. The computer program product of claim 13, wherein the computer usable program code for mapping the location of the requester on the network and the location of each content server on the network comprises:
computer usable program code for determining the location of the requester and each content server within the network based on a hierarchy.

15. The computer program product of claim 14, wherein the hierarchy comprises a hierarchy based on a subnet address, a zone, and a region.

16. The computer program product of claim 15, wherein at least one of the zone or the region has a property setting that determines whether the requester is permitted to download the file from a content server that is not located within the zone or the region.

17. The computer program product of claim 12, further comprising:
computer usable program code for determining, by a second content server, that the second content server has a copy of a replicated file that may be deleted;
computer usable program code for determining if the copy of the replicated file on the second content server is an only copy of the replicated file on the network;
computer usable program code, responsive to a determination that the copy of the replicated file on the second content server is not the only copy of the replicated file on the network, for deleting the copy of the replicated file from the second content server; and
computer usable program code for updating an entry for the replicated file indicating that the copy of the replicated file no longer exists on the second content server.

18. A data processing system for automatically replicating a file, the data processing system comprising:
a bus;
a communications unit connected to the bus;
a storage device connected to the bus, wherein the storage device includes computer usable program code; and
a processor unit connected to the bus, wherein the processor unit executes the computer usable program code to receive a request from a requestor to download the file; map a location of the requester on a network and a location of each content server on the network; determine that a copy of the file exists on a content server associated with the requester, based on the location of the requester and the location of the content server; in response to a determination that a copy of the file does not exist on a content server associated with the requester, determine a content server associated with the requester to which to replicate the file based on the location of the requestor and the location of the content server to form a determined content server; notify the requester of the determined content server; and replicate the file to the determined content server.

19. The data processing system of claim 18, wherein the processor unit further executes the computer usable program code to receive a first request to upload the file to be replicated from a first requester; determine a first content server to upload the file to; and generate an entry for the file, wherein the entry comprises a location of the first content server and a replication policy for the file, wherein the replication policy for the file is set to automatic.

20. The data processing system of claim 19, wherein the processor unit further executes the computer usable program code to update the entry to comprise each content server to which the file is replicated.
